(19) United States
(12) Patent Application Publication
(10) Pub. No.: US 2025/0108599 A1
(43) Pub. Date: Apr. 3, 2025

(54) DRYER AND SHAKER POWDER RECIRCULATING SYSTEM

(71) Applicant: Industrial Business Systems LLC, Gilbert, AZ (US)

(72) Inventors: Keith Hunt, Gilbert, AZ (US); Andy McDaniel, Gilbert, AZ (US)

(21) Appl. No.: 18/906,128

(22) Filed: Oct. 3, 2024

Related U.S. Application Data
(60) Provisional application No. 63/542,163, filed on Oct. 3, 2023.

(51) Int. Cl. B41F 19/00; B41F 16/02

(52) U.S. Cl. CPC B41F 19/002; B41F 16/02

(57) ABSTRACT

A dryer and shaker powder recirculating system for a direct-to-film print that includes a powder application container and a powder collection container. The system uses a vacuum, coupled to a compressor, to create a venturi suction that pulls powder from the collection container. The system also includes a joint, preferably a T-joint, that is coupled to a valve and the vacuum. The valve can be motorized, and the compressor can be tankless. The system also includes a filling tube that leads into the powder application container. The joint, vacuum, and filling tube are all connected via a series of tubes, which can be sealed against holes in the containers using tube clamps. The system can also include an inner tube that extends into the powder collection area.

This application claims the benefit of U.S. Provisional Application No. 63/542,163, filed Oct. 3, 2023, the contents of which are hereby incorporated by reference.

### FIELD OF THE INVENTION

The present specification relates generally to devices for direct-to-film (“DTF”) shaker and dryer and more specifically a system that recirculates the powder within the DTF shaker and dryer.

### BACKGROUND OF THE INVENTION

Traditional textile printing techniques have relied on methods such as screen printing and heat transfer printing, each of which has its limitations and drawbacks. Screen printing, while effective for large production runs, can be time-consuming and costly when dealing with complex or multicolored designs. Heat transfer printing may not always provide the desired vibrancy and durability in printed designs.

DTF printing emerged as a promising alternative, allowing for high-resolution, full-color designs to be directly applied to textiles and garments. In the DTF process, designs are printed onto a transparent or semi-transparent film, which is then transferred to the fabric through a heat and pressure application. Challenges exist in ensuring uniform ink or adhesive distribution on the DTF film and achieving consistent curing of the printed designs. The use of powdered inks or adhesives presents challenges related to ink or adhesive distribution, environmental concerns, and efficient utilization of resources. Conventional DTF shaker and dryer systems for powdered inks often result in wastage of excess powder, inefficient distribution, and environmental issues associated with powder disposal.

These problems are often caused by inefficient recirculating of the powder. Current methods include complex systems of using multiple auger screws driven by motors that transfer powder from the collection tray back to the powder hopper. These systems often fail due to powder being embedded within the screw drives and motors. Once these systems fail the powder is no longer circulated back onto the DTF film causing poor quality prints, waste of material and machine shutdown.

Therefore, there is a need for a need for a system that recirculates the powder within the DTF system without all the mechanical mechanisms.

### BRIEF SUMMARY OF THE INVENTION

Accordingly, the present invention relates to a dryer and shaker powder recirculating system for a direct-to-film (DTF) print. A typical powder application container in a DTF system has a powder inlet point at which powder is introduced into the container, a powder application chamber, and a means for managing and recirculating excess powder that removes powder from a powder recirculation exit point returns excess powder to the powder inlet point. The system is designed to efficiently manage the powder used in the printing process, reducing waste and improving the overall efficiency of the printing operation. The system includes several components that work together to collect, transport, and redistribute the powder.

A collector is positioned at the powder recirculation exit point of an existing powder application container to retrieve excess powder, while a venturi suction vacuum, generated by air passed through a narrowed section by a compressor, draws the powder from the collection area and propels it back to the powder inlet point.

The system also includes optional components such as a powder source connected to the system via a valve that allows controlled powder flow into the application container. A valve controller enables precise metering of powder flow, and a compressor controller regulates the strength of the vacuum source. In advanced embodiments, the system can automatically adjust powder dispersal using a sensor and system controller, which optimize the coordination between powder flow and vacuum strength to maintain desired powder levels in the application container. The system's modular design includes sealed ducts and connectors, ensuring secure and efficient powder movement throughout the recirculation process.

The system includes a powder collection container, which serves as the initial collection point for the powder. The container aligns with the powder recirculation exit point of the container. A first duct is coupled to the powder recirculation point This tube serves as the primary conduit for the powder, allowing it to be transported from the collection container to other parts of the system. The powder recirculation exit point and the first duct are designed to create a secure and efficient pathway for the powder, ensuring that it is effectively collected and transported with minimal loss or spillage.

The first duct is coupled to a joint, which serves as a connection point for several other components of the system. The joint is designed to be coupled to both a valve and a venturi suction vacuum source. The valve serves as a control mechanism, allowing the flow of powder through the system to be regulated as needed. The venturi suction vacuum source, on the other hand, is responsible for creating a venturi suction that pulls the powder from the collection container and into the system. The venturi suction vacuum source is coupled to a compressor, which aids in the creation of the venturi suction. The compressor is a tankless air compressor, which is designed to provide a consistent and reliable source of air pressure for the venturi suction vacuum source. This ensures that the venturi suction vacuum source is able to effectively pull the powder from the collection container and into the system.

The joint is also coupled to a distribution tube, which leads into a powder application container. The powder application container serves as a secondary collection point for the powder, where it is distributed onto the film having wet ink. The distribution tube allows the powder to be transported from the joint to the powder application container, ensuring that it is effectively distributed on the film. In some embodiments of the system, the joint is a T-joint. This design allows for the efficient distribution of the powder, ensuring that it is evenly distributed throughout the system. The valve is a motorized valve, which allows for precise control over the flow of powder through the system.

In some embodiments, the powder recirculation exit point in the powder collection container has an insert coupled to it. This insert extends into the powder collection area, ensuring that all of the powder is effectively collected and transported into the system. The first duct is sealed against the powder recirculation exit point, and a second duct, which is coupled to the venturi suction vacuum source, is sealed against a powder inlet point by a second tube clamp. This design ensures that the system is airtight, preventing any loss of powder or air pressure.

In some embodiments, the second tube clamp is coupled to a distribution tube. This allows the powder to be effectively distributed throughout the system, ensuring that it is evenly spread and ready for use in the printing process. The system is designed to be easy to use and maintain, making it a practical and valuable addition to any printing operation.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the. Absent such clear statements of intent to apply a “special” definition, it is the inventor's intent and desire that the simple, plain, and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for” and will also recite the word “function” (i.e., will state “means for performing the function of . . . , without also reciting in such phrases any structure, material or act in support of the function. Thus, even when the claims recite a “means for performing the function of molding a . . . , step for performing the function of molding a . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

Additional features and advantages of the present specification will become apparent to those skilled in the art upon consideration of the following detailed description of the illustrative embodiment exemplifying the best mode of carrying out the invention as presently perceived.

### BRIEF DESCRIPTION OF THE DRAWINGS

These and other features, aspects, and advantages of the present specification will become better understood with regard to the following description, appended claims, and accompanying drawings where:

FIG. 1 is a diagram of the dryer and shaker powder recirculating system in accordance to one, or more embodiments;

FIG. 2 is a isometric view of the dryer and shaker powder recirculating system in accordance to one, or more embodiments;

FIG. 3 is a side view of the dryer and shaker powder recirculating system in accordance to one, or more embodiments;

FIG. 4 is a cross section of FIG. 3 of the dryer and shaker powder recirculating system in accordance to one, or more embodiments; and

FIG. 5 is a bottom view of the dryer and shaker powder recirculating system in accordance to one, or more embodiments.

Elements and acts in the figures are illustrated for simplicity and have not necessarily been rendered according to any particular sequence or embodiment.

### DETAILED DESCRIPTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

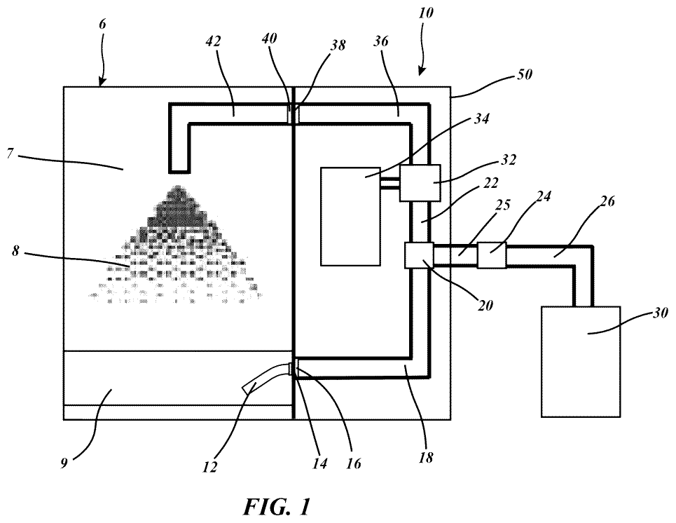

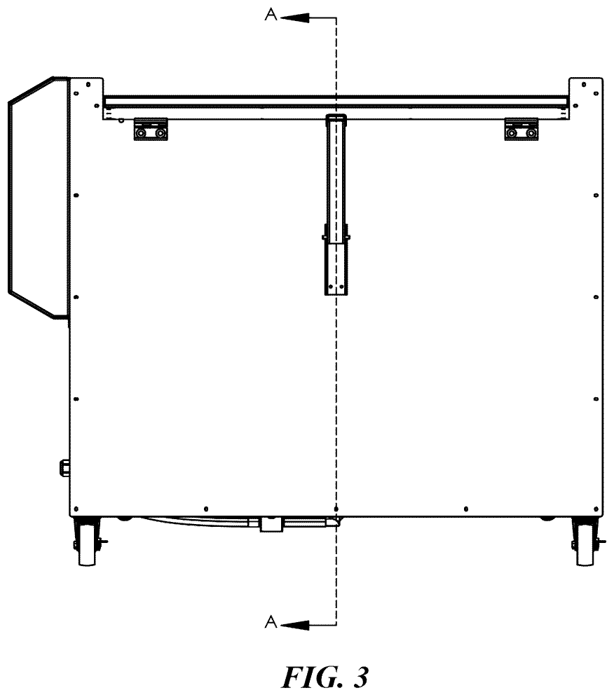

Referring initially to FIG. 1-5, a dryer and shaker powder recirculating system is shown generally at 10. The dryer and shaker powder recirculating system 10 for a direct-to-film print can have a powder application container 7 wherein the powder application container can distribute the powder 8 onto ink on the film. The dryer and shaker powder recirculating system 10 can comprise a powder collection container 9 which can collect powder 8 at or near the bottom of the DTF shaker and dryer 6. The powder collection container 9 can have a powder recirculation exit point 14 which can be located on any side of the DTF shaker and dryer. The powder recirculation exit point 14 can be sized to fit a duct 18 coupled about the hole with a first duct connection 16. The duct may be a tube or any other kind of substantially pressure sealed pathway. The first duct connection 16 can be such as, for example, compression fitting, flare fitting, barb fittings, threaded fittings, swage fittings, or the like.

The first duct connection 16 can be coupled to the first duct 18 on the outside of the powder collection container 9 and can be coupled to an insert 12 on the inside of the powder collection container. The insert 12 and the first duct 18 can be the same size or two separate sizes. The insert 12 can sit in or on the powder 8 at the bottom of the powder collection container such that the powder can be suctioned through the insert and the first duct 18 when a vacuum is applied. The insert 12 and the first duct 18 can be made of the same tube material of different tube material such as, for example, steel tube, aluminum tube, rubber tube, plastic tube, composite tube, or the like.

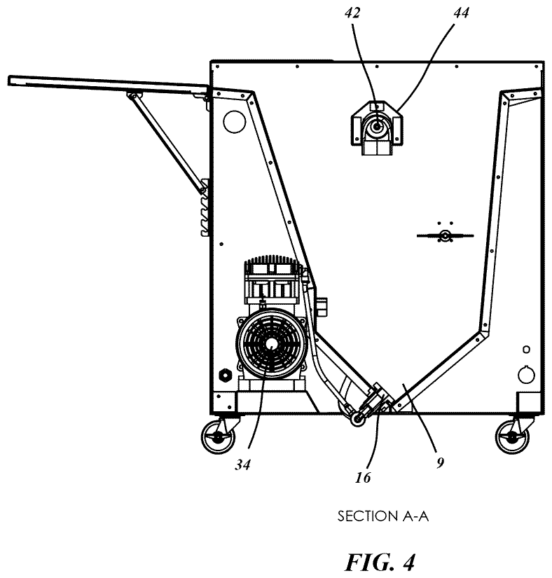

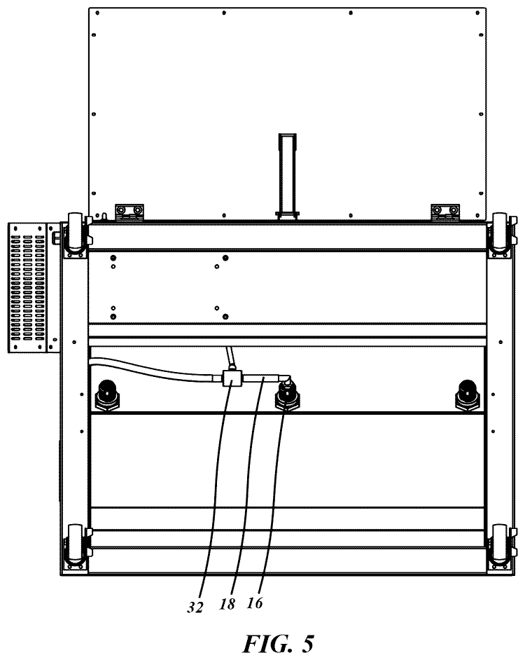

In certain embodiments the insert 12 and the powder container 30 can be omitted and there can be one or more one powder recirculation exit point 14 on the bottom of the powder collection container 9 as shown in FIGS. 4 and 5. The first duct 18 can be coupled to venturi suction vacuum source 32 which can be coupled to at least one first duct connection 16 on one end and the venturi suction vacuum source on the other end wherein the vacuum can be an air vacuum conveyor device. The powder collection container 9 can have more than one powder recirculation exit points 14. In certain embodiments, the first duct 18 can be attached to one or more first duct connections on the bottom of the powder collection container 9 wherein if there is more than one first duct connection a manifold or y-connection can be used to split the first duct to attach the other first duct connections to the venturi suction vacuum source 32 as shown in FIG. 5.

In embodiments, the powder collection container 9 can be open or can be closed with a cover in certain embodiments allowing only powder 8 to fall into the powder collection container allowing the powder to be suctioned through the first duct connection 16 and through the powder recirculation exit point 14. The first duct 18 can be coupled to a joint 20 wherein the joint can be such as for example, T-joint, straight tee, reducing tee, barred tee, lateral tee, pipe threaded tee or the like. The first duct 18 can be coupled to the joint 20 by such as, for example, barred, swage, push to lock, clamped or the like. The joint 20 can be coupled to a powder source duct 25 and a continuation duct 22 wherein the powder source duct 25 and continuation duct 22 can be coupled to the joint by such as, for example, barred, swage, push to lock, clamped or the like.

The powder source duct 25 and the continuation duct 22 can be the same or differing material type as the first duct 18. The powder source duct 25 can be coupled to a valve 24 wherein the valve can be such as, for example, motorized valve, gate valve, ball valve, globe valve, control valve, ball check valve, or the like. The valve 24 can open and close either manually or automatically when powder is needed in the system. In certain embodiments, one or more sensors can be coupled to the inside of the powder collection system 9 and/or the powder application container 7 which can measure the powder flow, the amount of powder in the collection container, the amount of powder distributed on the film, or the like.

In embodiments, the valve can be coupled to directly to the powder container 30 or can be coupled to a powder container tube 26 which can be coupled to the powder container 30. The powder container 30 can be such as, for example, bulk powder container/hopper, conical hopper, screw conveyor hopper, rotary valve hopper, vibratory hopper, funnel hopper, cylindrical container, or the like. The powder container 30 can allow more powder to enter the system or in other embodiments allow the powder in the system to be placed back into the powder container depending on the user's needs and how much powder 8 is in the system. The continuation duct 22 can be couple to a venturi suction vacuum source 32 or the venturi suction vacuum source can be directly coupled to the joint 20. The venturi suction vacuum source 32 can be coupled to a compressor 34 wherein the venturi suction vacuum source and the compressor can create a compressed air venturi vacuum wherein the compressed air can be used as a primary fluid to create the vacuum wherein the compressed air can be forced through the vacuum or a nozzle or converging section creating a high-speed flow. As the air accelerates, it can draw in the air creating a vacuum. In certain embodiments, the vacuum 32 can be such as, for example, steam venturi vacuum, liquid venturi vacuum, gas venturi vacuum, multi-stage vacuum or the like. In embodiments, the user can control the suction of the vacuum 32 by increasing or decreasing the flow of the compressor 34. The compressor 34 can be such as, for example, tankless air compressor, rotary compressor, jet, compressor, centrifugal compressor, or the like. The compressor 34 can be coupled to outside or inside of the DTF shaker and dryer 6.

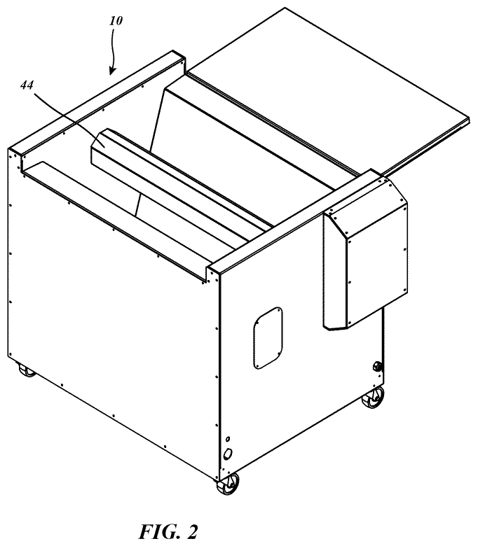

The venturi suction vacuum source 32 can be coupled to a second duct 36. The DTF shaker and dryer 6 can have a powder inlet point 38 wherein the second duct 36 can be coupled to the powder inlet point by a powder source duct connection 40 being the same as and having the same properties as the first duct connection 16. The second duct 36 can be coupled to the powder source duct connection 40 which can be such as, for example, T-joint, straight tee, reducing tee, barred tee, lateral tee, pipe threaded tee or the like. The powder source duct connection 40 can be coupled to a distribution tube 42 wherein the distribution tube can be stiff or flexible and can spray or drop powder 8 into the powder application container 7. In certain embodiments, the second duct 36 can be coupled to the powder inlet point 38 and can be directly coupled to a distribution tube 42 or the second duct and distribution tube can be the same tube. The powder 8 can flow through the distribution tube 42 and exits the distribution tube onto the film (not shown). The sag in the film can allow for powder 8 to collect on it and as the film is pulled through the shaker, the powder can tumble on the film and stick to the wet ink. The distribution tube 42 can be covered by a distribution tube cover 44 which can be coupled to the DTF shaker and dryer 6 and can direct the powder down onto the film as shown in FIG. 2. The distribution tube cover 44 can be such as, for example, sheet metal, half a tube, plastic of the like that can cover the distribution tube 42.

In embodiments, the recirculating system 10 can be encapsulated by an outer shell 50 or partially encapsulated by an outer shell and some of the components are fully or partially in the DTF shaker and dryer 6. The recirculating system 10 can be permanently or removably attached to the DTF shaker and dryer 6. In certain embodiments, the powder container 30 can be on the outside or inside of the outer shell 50 and the valve 24 can be coupled to the outer shell allowing the user to connect and remove the powder container tube 26 and the powder container 30 from the system.

In other embodiments, the recirculating system 10 can have the joint 20, the continuation duct 22, the valve 24, the powder source duct 25, the powder container tube, and the powder container omitted, and the first duct can be coupled directly to the venturi suction vacuum source 32. The powder 8 can be collected at the bottom of the cavity of the powder collection container 9 eliminating the need for the powder container 30. The venturi suction vacuum source 32 can pull the powder 8 from the powder collection container 9 and move the powder from the powder collection container to the distribution tube 42 distributing the powder onto the film that has wet ink on it. The excess powder can fall off of the film and back into the powder collection container 9.

In some embodiments, the recirculating system can include a fluidized bed (not shown). A fluidized bed is a system in which solid particles are suspended and behave like a fluid when a gas or liquid flows upward through the material. As the gas or liquid passes through, it creates enough upward force to lift and separate the particles, causing them to move freely. Because the solid powder particles are constantly in motion, fluidized beds help prevent issues like clumping and uneven distribution of material. Agitation or vibration may also be used to prevent clumping and aid in keeping the powder particles fluid.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

What is claimed is:

1. A dryer and shaker powder recirculating system for a direct-to-film print having a powder, a powder application container, a powder inlet point, and a powder recirculation exit point, and a collection area, the system comprising:
a collector having a collection end, the collector configured to access the powder application container at the powder recirculation exit point and extend the collection end into the collection area;
a first duct to provide fluid communication between the insert and a narrowed section;
a compressor that pushes air through the narrowed section;
a second duct to provide fluid communication from the narrowed section to the powder inlet point;
wherein the flow of air from the compressor through the narrowed section creates a venturi suction vacuum source that draws the powder from the collection area and propels the powder to the powder inlet point.

2. The dryer and shaker powder recirculating system according to claim 1, further comprising a powder source coupled to the first vent via a valve such that the venturi suction vacuum source pulls powder from the powder source when the valve is open.

3. The dryer and shaker powder recirculating system according to claim 2, further comprising a valve controller configured to allow a user to control the valve to meter powder flow from the powder source to the powder application container.

4. The dryer and shaker powder recirculating system according to claim 1, further comprising a connector that seals the first duct to the powder recirculation exit point.

5. The dryer and shaker powder recirculating system according to claim 4, wherein the connector is a tube clamp.

6. The dryer and shaker powder recirculating system according to claim 1, further comprising a connector that seals the second duct to the powder inlet point.

7. The dryer and shaker powder recirculating system according to claim 2, wherein the powder source is coupled to the first duct through a third duct that houses the valve and joins to the first duct at a T-joint.

8. The dryer and shaker powder recirculating system according to claim 2, wherein the valve is a motorized valve.

9. The dryer and shaker powder recirculating system according to claim 1, wherein the compressor is a tankless air compressor.

10. The dryer and shaker powder recirculating system according to claim 1, wherein the collector is an insert that extends into the collection area.

11. The dryer and shaker powder recirculating system according to claim 1, further comprising a compressor controller that is configured to allow a user to control the strength of the venturi section vacuum source.

12. The dryer and shaker powder recirculating system according to claim 1, further comprising:
a powder source coupled to the first vent via a valve such that the venturi suction vacuum source pulls powder from the powder source when the valve is open;
a valve controller configured to allow a user to control the valve to meter powder flow from the powder source to the powder application container
a compressor controller that is configured to allow a user to control the strength of the venturi section vacuum source; and
a system controller configured to allow a user to coordinate the strength of the vacuum source and status of the valve to optimize powder dispersal in the powder application container.

13. The dryer and shaker powder recirculating system of claim 12 further comprising a sensor coupled to the system controller that senses the level of powder dispersal in the powder application container, wherein the system controller automatically adjusts the compressor controller and the valve controller to create a desired powder dispersal level.

14. A method of recirculating powder in a a direct-to-film print having a powder, a powder application container, a powder inlet point, and a powder recirculation exit point, and a collection area, the method comprising the acts of:
providing a circulator comprising a collector having a collection end, the collector configured to access the powder application container at the powder recirculation exit point and extend the collection end into the collection area, a ductworks configured to connect a narrowed section between the powder inlet point and the powder recirculation exit point, and a compressor that pushes air through the narrowed section;
connecting a collection end of the ductworks to the powder recirculation exit point and a distribution end of the ductworks to the powder inlet point;
engaging the compressor to pass air through the narrowed section to creates a venturi suction vacuum source that draws the powder from the collection area and propels the powder to the powder inlet point.

15. The method of claim 14, further comprising coupling a powder source to the ductworks via a valve such that the venturi suction vacuum source pulls powder from the powder source when the valve is open and the compressor is engaged.

16. The method of claim 15, further comprising controlling the valve to meter powder flow from the powder source to the powder application container.

17. The method claim 14, further comprising sealing the ductworks to at least one of the powder recirculation exit point and the powder inlet point.

18. The method of claim 14, further comprising controlling the compressor to selectively manage the strength of the venturi section vacuum source.

19. The method of claim 14, further comprising:
coupling a powder source to the ductworks via a valve such that the venturi suction vacuum source pulls powder from the powder source when the valve is open and the compressor is engaged;
selectively controlling the valve to meter powder flow from the powder source to the powder application container;
selectively controlling the strength of the venturi section vacuum source; and
coordinating the strength of the vacuum source and status of the valve to optimize powder dispersal in the powder application container.

20. The method of claim 19, wherein the strength of the vacuum source and the status of the valve is automatically coordinated to maintain a desired powder saturation level.
